(19) United States
(12) Patent Application Publication
(10) Pub. No.: US 2014/0292655 A1
(43) Pub. Date: Oct. 2, 2014

(54) RAT

(71) Applicant: James Lawrence Kearns, Jacksonville, FL (US)

(72) Inventor: James Lawrence Kearns, Jacksonville, FL (US)

(21) Appl. No.: 13/855,303

(22) Filed: Apr. 2, 2013

(51) Int. Cl. G06F 3/033

(52) U.S. Cl. CPC G06F 3/0334
USPC 345/163

(57) ABSTRACT

This device is new and allows the operator to wear the device over a foot or shoe in order to operate a mouse, which is the primary “flash of genius” and includes a number of variable logo designs to suit the preference of the user. It permits “hands-free” operation of the mouse and engages the feet rather than the hands. Design modifications incorporate a right and left click by tapping on the side of a desk, chair or other foot. The novelty of the system is the ability to wear the item as a normal operated mouse, that is termed as a rat. It incorporates the existing wireless technology, but the new system is allowing it to be worn over the socked foot or shoe allowing the user to become a part of the computer. It is not intended to be worn as a shoe outside of operating a computer.

### BACKGROUND OF THE INVENTION

### Field of the Invention

This invention relates to a design for a new type of “mouse” which will enable the user to be totally “hands-free” in normal computer functions concerning a mouse. In the current technology, the computer user must remove either the right or left hand from the keyboard in order to operate the mouse, but with this new technology, the hands are not used to manipulate and operate this mouse. This will provide help for persons who are disabled and do not have the use of both hands may use a computer more easily. This is accomplished by the development of a mouse, which may be operated by using the feet, through the use of a “foot-operated” mouse, therefore the term “Rat.” The device consists of an infrared mouse, which acts as the normal functioning currently available roller ball for the mouse and three, or more offset foot side strikes, which are “right-click”, “left-click”, and “hold”. The infrared mouse is attached to the front of a shoe type device, which is made in the shape of a rat or designed type of functioning logo such as NFL Logos, College Logos or other type designed logos to accommodate a user's preference. Diagrams are included to show the design for the non-provisional utility patent design.

The advantages of this new “invention” are to allow for:
Hands-free mouse functions.
Faster typing with possibly fewer errors.
Greater usable desk space.
Help for people who do not have the use of both hands while typing.
Engaging foot and leg motion while operating a computer.
Marketable as new technology for computers, or as a novelty device, incorporating different preferential logos of favorite NFL, NBA, College Teams, etc., it can be easily adapted to all computers in use today, both for home and business.
It is worn over the foot or existing shoe which is the “flash of genius” required for a patent to be granted along with “side strikes” that are not in use in a normal mouse.

Currently used systems incorporate a movable or stationary mouse system but as yet no known systems allow the individual to “wear” the mouse while operating the device with a plethora of logo designs available for the user's preference. Some known systems, such as U.S. Pat. No. 8,314,722 by Coe, Stanley S. engages the hand and U.S. Pat. No. 5,259,439 by Lee, et al, engage the feet, but none to date allow for the user to “wear” the device on a foot or over the existing shoe.

Current systems use a small device known as a “mouse” which is used to control the pointer system of the program and it requires the user to remove his hands from the keyboard and point and click in the area he needs to access or on the program he needs to open. This causes a slowdown of the user by having to remove his hands while having to type and the new invention will utilize a foot operated system, which is enclosed in a “shoe” type device. This system will differ from all prior art and is not obvious because it will enclose the mouse system in a shoe and not be hand held and will move the right and left click bars to the side of the shoe, whereas prior art is on the top. Additionally, the scrolling wheel is moved to the front and on the bottom so that program pages such as Word or others may be scrolled with a foot motion and not with a hand motion.

### BRIEF SUMMARY OF THE INVENTION

This invention allows “hand-free” motion to move a “mouse” and will provide that the feet are engaged to operate a computer system while typing or surfing the net. In addition, it covers either the whole shoe or socked foot, and will provide aid to persons who do not have the use of both or either hand to operate a computer system far easier. The drawing(s) depicted will show the ways in which a myriad of different logos will be used to promote a person's individual preference for type of “foot-mouse” from now on referred to as “rat.” The “flash of genius” is in allowing it to be worn over the foot and the design changes of the system.

### BRIEF DESCRIPTION OF THE SEVERAL VIEWS OF THE DRAWING

FIG. 1 shows the primary diagram of the device from a side view to illustrate the design and function of the system.

Item 1 shows the logo design implemented as a rat or jaguar or other variable design.

Item 2 shows the roller ball configuration being moved to the bottom and front of the device that would be utilized while scrolling.

Item 3 depicts the use of existing developed wireless infrared technology to connect the mouse to the computer in a desired program being operated.

Item 4 shows the foot or shoe inserted in the open area of the device to allow for operation by the foot.

Item 5 simply represents the leg of the person operating the device.

Item 6 shows the location of the battery pack to provide power to the device.

Item 7 is representative of a type of tail, which can be utilized as an antenna if required.

Item 8 shows the right strike pad that is used for right click.

Item 9 is representative of the USB receiver.

Item 10 represents a heavier sole area although it is not used to walk with.

Item 11 represents the internal circuit board of the device.

Item 12 is the left strike not visible in this drawing view.

Item 13 is the barrier between the foot and the scrolling wheel.

### DETAILED DESCRIPTION OF THE PREFERRED EMBODIMENT

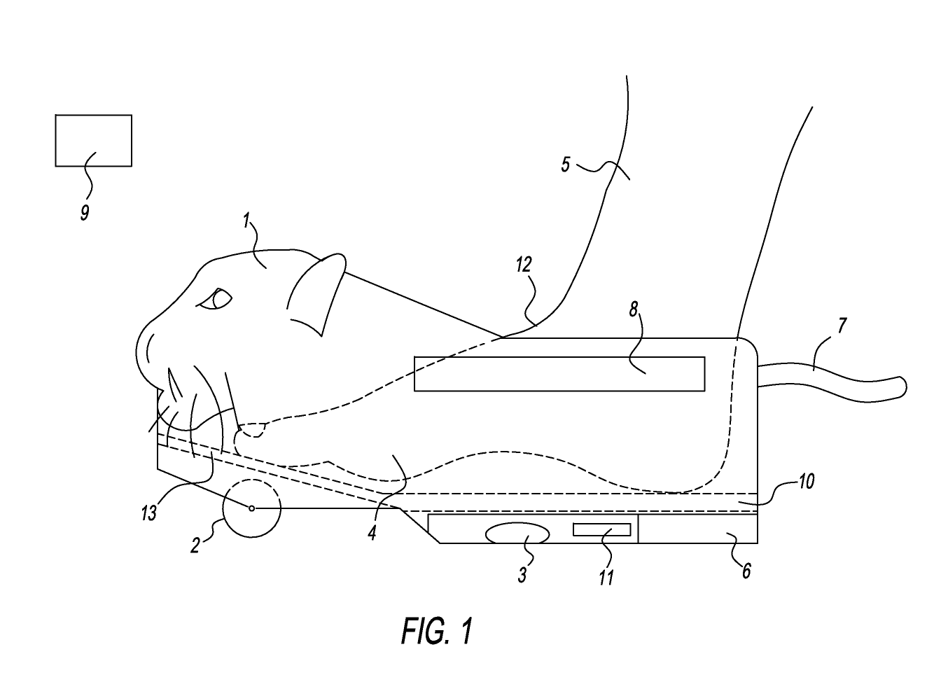

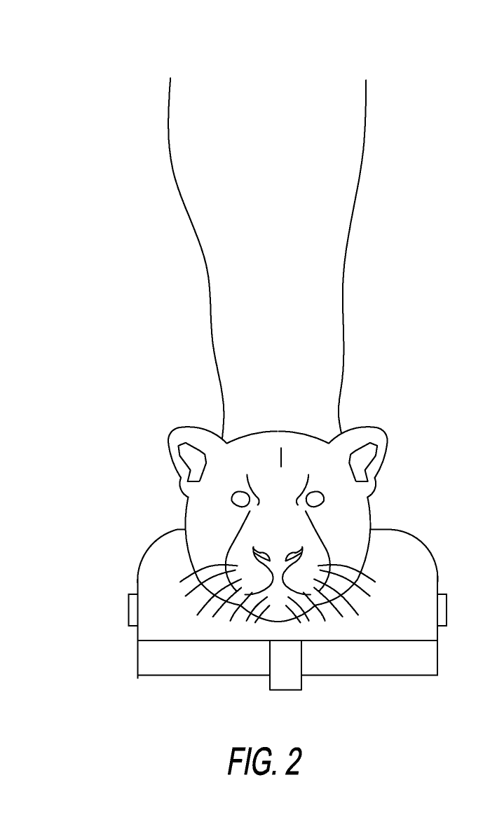

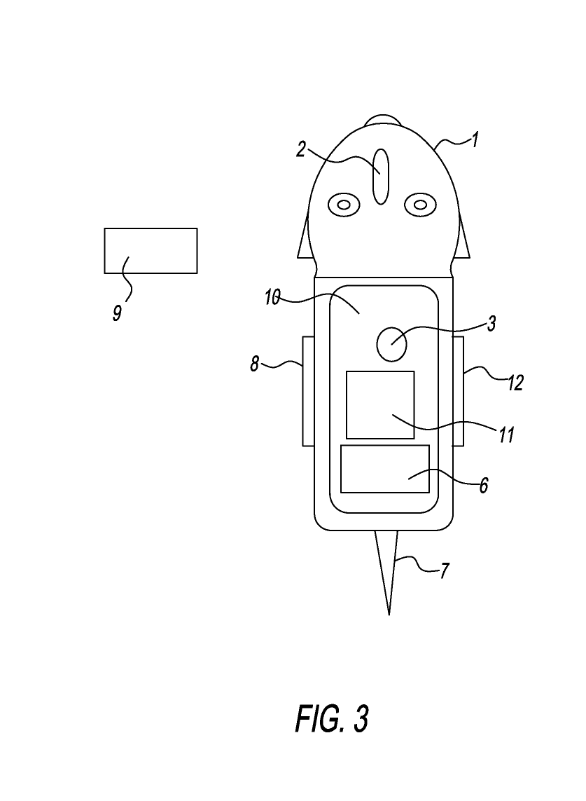

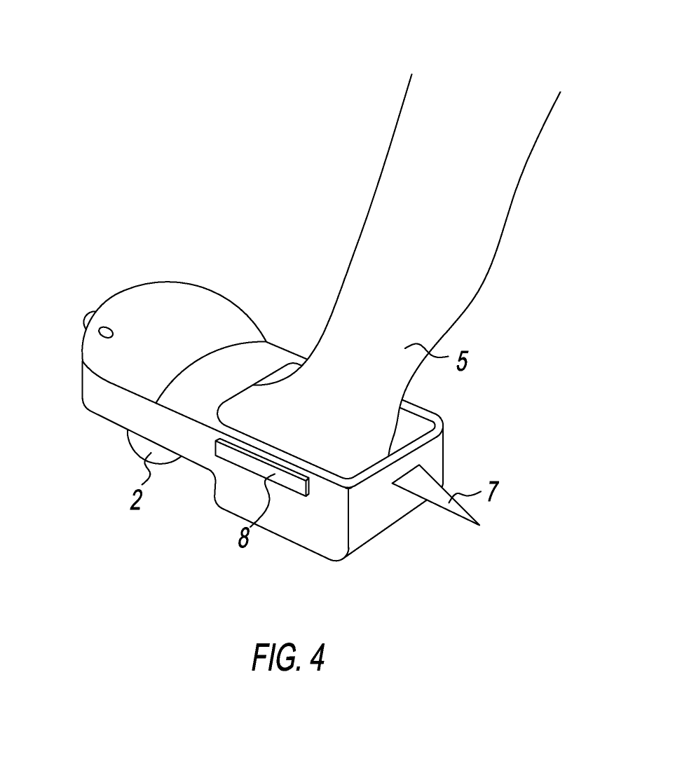

As depicted in the drawing of FIG. 1, Item 1, is representing the plethora of designs that can be incorporated in the head of the system to suite the user, and is primarily decorative in nature, but serves as the front of the device to enclose the mouse roller ball and infrared systems and functions. It is part of a “shoe” that is worn over a foot, either the whole existing shoe, or a socked foot. As further depicted in the drawing, Item 2 is the existing technology of a scrolling, wheel or ball used for scrolling in a normal mouse, usually on top, but in this case, for function, is moved to the bottom and slightly up to allow that a forward tipping motion will engage the scrolling of the rat. As further depicted in this drawing, Item 3 is the infrared scanner system that is used with normal existing mouse technology but is now moved to the rat bottom and is moved by a foot against a hard or course carpeted surface, to allow for “hands-free” motion of the rat. Further, the drawing shows the primary design (Item 4) that will allow the user to actually wear the rat as a functioning part of the computer system and provide for flawless typing without having to move the hands from the keyboard. It shows the foot inside the designed system. Item 5 is self-explanatory and simply shows the leg of the user. As depicted in the drawing, Item 6 is the battery pack area used on a normal wireless mouse and is stationed at the back or where most suitable.

The antenna as shown in Item 7 is primarily decorative in nature, but can also double as an antenna as needed to send and receive the signals from the USB receiver in Item 9. As further depicted in the drawing, Item 8 is the left strike that is used as left click for regular computer operations of left click in moving to an area of work on a computer screen. Since it may be difficult to hold as in a normal operation of a hand held mouse, the hold is established by clicking three times in succession and released by clicking once more. Item 10 is showing the sole of the “shoe” that would be for placing the foot flat on a surface and sliding to move the arrow on the screen to show where it will be clicking from the computer mouse actions. The drawing further represents the internal circuit board systems in item 11 that are a part of the inner workings of a regular mouse, that are understood to be needed for function, but are not depicted in detail here. Item 12 is representative of the right striker that is not able to be seen in this drawing, but is mirrored by Item 8 and is used as a means of left click used for left click operations in a normal computer mouse configuration. Item 13 is the represented barrier between the foot or shoe of the operator and the scrolling wheel. One option may be to allow the foot to touch and move the scrolling wheel with the foot, but this is not considered to be practical.

### BRIEF DESCRIPTION OF FIG. 3 DRAWING

Item 1 is a representation of the many plethora of designs that may be used as the type to suit the preference of the user.

Item 2 is showing the scrolling wheel.

Item 3 is the infrared light.

Items 4 and 5 are omitted, as they are the leg and foot not shown.

Item 6 is the battery pack.

Item 7 is the tail.

Item 8 is the left click bar.

Item 9 is the receiver.

Item 10 is the heavy sole.

Item 11 is the circuit boards of the mouse.

Item 12 is the right click bar.

Item 13 is not shown but would be the barrier between the foot and scrolling wheel.

### DETAILED DESCRIPTION OF FIG. 3

As shown in the drawing, Item 1 is representing all types of different designs that could be used according to the preference of the user and are only decorative. They may include NFL, NBA, NBA logos and designs of any type, known or unknown, or virtually any design as described in claim 4. Item 2 is showing the scrolling wheel which is lifted slightly to provide that the user would tip the device forward and pull back or move forward to scroll as described in claim 3a. Item 3 is showing the infrared light that picks up the position of the mouse pointer and registers it on the screen. It is previously developed technology that is utilized in this patent application to adapt for the use of the foot rather than a hand to move the mouse pointer. Items 4 and 5 are omitted from the drawing in this view but this is the primary “flash of genius and novelty” of the item that is not obvious to allow it to be worn by the user that will permit the application to be granted which is described in claim number 1 and 2 of the claims. Item 6 is simply the battery pack that is used as the method to power the item and should include an AA battery. Item 7 is the depiction of a decorative tail that would double as an antenna if needed and is variable depending upon the type of logo design used for the system in item 1 and described in claims 4, 7 and 8. Item 8 will function as the normal left click bar and as previously stated it is established by clicking 3 times in succession to produce the highlight function of the hold and released by clicking once against a chair, other leg or desk etc. as described in claim 3b. Item 9 represents the receiver of the system, which is understood as necessary to accomplish this design modification. Item 10 is simply showing the type of design that would incorporate a heavy sole area to keep the device from wearing out during use due to the heavy foot and leg putting pressure on the system which are described in claims 1 and 2. Item 11 is representative of the understood working circuitry of the existing mouse types that are infrared and are necessary to accomplish this patent application design. Item 12 is representative of the right click bar which will function as a normal right click on a mouse, but is on the side and not on the top which is described in claim 3b. Item 13 is not shown but is understood as a barrier to prevent the feet from touching the scrolling wheel. Another modification may allow the omission of this barrier to allow for the feet to touch and move the scrolling wheel as needed. FIG. 2 is a frontal view and FIG. 4 is an overhead view with the same basic functions of the device being shown.

1) An independent claim of a device that is worn over the foot, either the whole existing shoe of the operator or the socked foot of the computer operator to act as a normal mouse in computer operations.

2) An independent claim of enclosing a wireless mouse system inside of a shoe type device for normal mouse operations.

3) A mouse device that is operated by a foot that will replace the existing wireless mouse configurations comprising:
a) The roller wheel for scrolling now placed on the front of the device and below and upward slightly to allow for scrolling by the foot with a forward tipping motion.
b) Strikers placed on the side of the device to allow for left and right clicks of the device against a hard surface such as another shoe, desk or chair.

4) Rat name and design system that comprises variable logo designs to meet the preference of the user(s) for a foot operated mouse that is worn over a shoe or foot.

5) Left click hold by tapping 3 times in succession to initiate the hold function that is normally done by holding down on the left click bar. This function allows the mouse operator to highlight areas for cut and paste, etc.

6) Faster typing with fewer errors as the system allows the user to “become a part of the computer.”

7) Greater usable desk space due to the system engaging the feet.

8) Activity which produces some exercise of the legs while operating a computer.
